(19) United States
(12) Patent Application Publication
(10) Pub. No.: US 2009/0233646 A1
(43) Pub. Date: Sep. 17, 2009

(54) Interference Cancellation in Sector Antenna

(75) Inventors: Baruch Cyzs, Kiryat-Motzkin (IL); Oren Amidan, Tzur-Yigal (IL); Pinhas Sabach, Jerusalem (IL)

Correspondence Address: MARTIN D. MOYNIHAN d/b/a PRTSI, INC., P.O. BOX 16446, ARLINGTON, VA, 22215, US

(73) Assignee: Pallasium Ltd., Ariel (IL)

(21) Appl. No.: 12/084,428

(22) PCT Filed: Nov. 2, 2006
(86) PCT No.: PCT/IB2006/054074

§ 371 Date: May 1, 2008

Related U.S. Application Data
(60) Provisional application No. 60/732,591, filed on Nov. 2, 2005.
(60) Provisional application No. 60/740,089, filed on Nov. 28, 2005.

(51) Int. Cl. H04M 1/00; H04W 72/00

(52) U.S. Cl. 455/562.1; 370/329

(57) ABSTRACT

A method of communicating in a cellular network including a multi-sector point to multipoint base station, having a plurality of antennas covering primarily non-overlapping zones. The method includes allocating bandwidth to a subscriber station in each of the zones, which bandwidth is on a single channel, such that if the subscribers were adjacent each other their transmissions on the allocated bandwidth would interfere with each other, transmitting signals from the subscribers to the base station through the antennas of the respective zones in which they are located, on the allocated bandwidth and processing the signals from each of the subscribers so as to cancel interference from others of the subscribers in interpreting the signals by the base station.

### RELATED APPLICATION

The present application claims the benefit under 35 USC 119(e) of U.S. Provisional application 60/732,591 filed Nov. 2, 2005 and of U.S. provisional application 60/740,089, filed Nov. 28, 2005, the disclosures of which are incorporated herein by reference in their entirety.

### FIELD OF THE INVENTION

The present invention relates to communication systems and in particular to sector antennas.

### BACKGROUND OF THE INVENTION

Subscriber stations (e.g., telephones, personal digital assistants (PDAs), laptops, computers, television sets, machines with cellular communication ability) are widely used in many countries. Generally, base stations that service the subscriber stations are positioned in a plurality of locations, each base station covering a cell in which it provides communication services. In order to provide continuous service, the cells partially overlap. This, however, involves interference between the transmissions of neighboring base stations. Therefore, neighboring base stations generally use different frequencies, codes or time-slots in order to avoid interference.

Some base stations employ omni-direction antennas which transmit with even power in all directions surrounding the antenna. Other base stations employ three sector antennas, each of which transmits to a different sector of the cell. As in the case of neighboring antennas, the transmissions of the different sector antennas may interfere with each other, and hence, the different sectors generally use different frequencies. As there is an increasing demand for communication services of subscriber stations, attempts are made to increase the usage of the available frequencies.

U.S. Pat. No. 7,103,384 to Chun, dated Sep. 5, 2006, the disclosure of which is incorporated herein by reference, describes a method for multi-use of the same frequency, referred to as a Smart Antenna method. The method involves positioning four antennas within a cell at different locations and using the received signals at the different antennas to estimate the transmitted signals of up to 3 subscriber stations. In a sector variation, each sector is serviced by four sector antennas, allowing communication with up to three subscriber stations in the sector, using the same frequency and time slot.

U.S. Pat. No. 6,792,290 to Proctor Jr. et al., the disclosure of which is incorporated herein by reference, describes use of an adaptive antenna system. In this type of system an auxiliary antenna is added to the ‘main’ antenna only for cancellation of interference from other units.

There are many other methods of increasing the frequency utilization and the data rate per frequency, but there is a continuing need for methods of increasing the cellular network capacity.

### SUMMARY OF THE INVENTION

An aspect of some embodiments of the present invention relates to utilizing the same frequency for concurrent transmission in two or more sectors of a base station sector antenna communicating with subscriber stations in a point to multipoint (e.g., cellular) network. Using the same frequency for a plurality of sectors achieves a higher bandwidth utilization and reduces the occurrences of handover of mobile stations.

In some embodiments of the invention, an adaptive interference cancellation method continuously calculates weights used cancel inter-sector interference. Since the interference from other sectors is generally substantially lower in power than the primary signals received, interference cancellation with sufficient quality is achievable without utilizing dedicated antennas for interference estimation. The cancellation is optionally performed entirely in signal processing in adjusting the transmitted signals and the interpretation of the received signals, without requiring additional antennas or other transmission or reception hardware. In some embodiments of the invention, the subscriber stations do not require any adaptations for implementation of the inter-sector interference cancellation and the base stations require only changes in the PHY and MAC layers.

In some embodiments of the invention, predetermined signals of known values are transmitted periodically on the uplink channel, e.g., in pilot signals and/or in a preamble of each transmitted data frame, and received values of the predetermined signals are used in determining and/or adjusting weights which are used in calculating the cancellation signals to be used. Optionally, for example in time division duplex (TDD) transmissions, the same weights are used for the uplink and downlink channel, possibly adjusted for transceiver response. Alternatively or additionally, the subscriber stations determine the weights of the downlink direction and periodically transmit the weights to the base station which performs the cancellation.

In some embodiments of the invention, for example when OFDM or OFDMA are used, cancellation is performed separately for each sub-carrier frequency. Alternatively, the sub-carriers are grouped together into bins and the same weights are used for all frequencies in the bin.

Optionally, the base station dynamically determines whether to use the same frequency for some or all of the sectors, or to use different frequencies for different sectors. When the signal quality is low due to unsuccessful interference cancellation, different sectors are optionally assigned different channels, for example different sub-carriers and/or different time slots.

An aspect of some embodiments of the present invention relates to a frequency reuse scheme of a point to multipoint (e.g., cellular) network of base stations comprising sector antennas, in which at least directly neighboring base stations do not use any common frequency bands. While not allowing even the more distanced sectors of directly neighboring base stations to use the same frequency may require using a larger number of frequency bands, the advantages in such distancing is considered herein to outweigh the disadvantages.

An aspect of some embodiments of the present invention relates to a point to multipoint network in which some or all of the transmitters have times at which they do not transmit. In assigning channels to subscriber stations, the base stations take into account the location of the subscriber station and hence the neighboring base stations from which interference is expected, and the times at which the neighboring base stations do not transmit.

There is therefore provided in accordance with an exemplary embodiment of the invention, a method of communicating in a cellular network, comprising providing a multi-sector point to multipoint base station, including a plurality of antennas covering primarily non-overlapping zones, allocating bandwidth to a subscriber station in each of the zones, which bandwidth is on a single channel, such that if the subscribers were adjacent each other their transmissions on the allocated bandwidth would interfere with each other, transmitting signals from the subscribers to the base station through the antennas of the respective zones in which they are located, on the allocated bandwidth and processing the signals from each of the subscribers so as to cancel interference from others of the subscribers in interpreting the signals by the base station.

Optionally, the plurality of antennas are located in a single location possibly on a single tower. Optionally, the plurality of antennas comprise directional antennas. Optionally, each of the zones covers a sector surrounding the base station and the zones together cover the entire surroundings of the base station. Optionally, processing the signals comprises adding to each of the received signals a weighted sum of the signals received by one or more other antennas, the weights being designed to cancel interference from the subscribers generating the signals received by the other antennas. Optionally, transmitting the signals from the subscribers comprises transmitting signals which intermittently include values known by the base station in advance and comprising using the received values of the transmitted known values in determining weights for the weighted sum. Optionally, transmitting the known values comprises transmitting to the plurality of antennas concurrently, signals which are orthogonal to each other.

Optionally, the adding of the weighted sum of the signals of the one or more other antennas is performed after the signals are handled by an equalizer or alternatively before the signals are handled by an equalizer. The method optionally includes transmitting data signals from the base station through the plurality of antennas concurrently, on a single channel. Optionally, the data signals transmitted from the base station are corrected for inter-sector interference before their transmission. Optionally, the correction of the data signals transmitted from the base station is performed using downlink weights determined from a transfer function of signals transmitted to the base station. Optionally, the downlink weights are derived from uplink weights used in correcting signals received by the base station, by multiplying by an internal transfer factor between the plurality of antennas.

Optionally, the base station periodically transmits test signals between the plurality of antennas and accordingly determines the internal transfer factor. Optionally, the periodically transmitted test signals are transmitted during a guard time between an end of a first transmission frame and a beginning of a subsequent transmission frame. Optionally, each zone is covered only by a single antenna belonging to the base station. Optionally, transmitting signals from the subscribers to the base station comprises transmitting on a plurality of sub-carriers and wherein processing the signals comprises processing the signals using weights determined separately for a plurality of bins of sub-carriers, each bin including one or more sub-carriers. Optionally, at least one bin includes a plurality of sub-carriers. Alternatively, each of the bins includes only a single sub-carrier. Optionally, providing the base station comprises providing a base station in which each of the plurality of antennas covering primarily non-overlapping zones is associated with an additional antenna covering substantially the same zone. Optionally, the plurality of antennas covering primarily non-overlapping zones and the associated additional antennas are employed together in accordance with a MIMO architecture.

Optionally, processing the signals comprises adding to the signal received from a first subscriber, a weighted sum of the signals received through each of the antennas not included in the same sector as the antenna through which the signal from the first subscriber was received.

Optionally, processing the signals from each of the subscribers comprises based on a transfer function measured on previously transmitted test signals. Optionally, the previously transmitted test signals and the processed signals are transmitted on different frequencies.

Optionally, a value determined for use in the processing of the signals is determined from the previously transmitted test signals by interpolating from test values of frequencies adjacent to the frequencies of the processed signals.

There is further provided in accordance with an exemplary embodiment of the invention, a method of communicating in a cellular network, comprising providing a multi-sector point to multipoint base station, including a plurality of antennas covering primarily non-overlapping zones, generating signals to be transmitted concurrently through the plurality of antennas, processing the generated signals so as to cancel interference between the signals when transmitted through the plurality of antennas; and transmitting the processed signals through the antennas concurrently, on a single channel, such that if the antennas covered overlapping zones the signals would substantially interfere with each other.

Optionally, the base station comprises at least three antennas. Optionally, processing the generated signals comprises adding to each signal a weighted sum of the signals to be transmitted through the other antennas. Optionally, processing the generated signals comprises processing after the signals are inverse Fourier transformed.

There is further provided in accordance with an exemplary embodiment of the invention, a multi-sector base station, comprising a plurality of antennas adapted to communicate with primarily non-overlapping zones, a plurality of reception paths each adapted to handle signals received through a respective one of the antennas and an inter sector interference cancellation unit adapted to add to a first reception path a weighted sum of the signals received by the other reception paths, wherein weights of the weighted sum are selected responsive to an inter-sector interference level.

Optionally, the plurality of antennas comprise directional antennas. Optionally, the cancellation unit is adapted to receive received values of signals of predetermined known transmitted values and accordingly determine the weights. Optionally, the cancellation unit is adapted to add the weighted sum after an equalizer in the reception path. Optionally, the cancellation unit is adapted to add the weighted sum before an equalizer in the reception path.

Optionally, the cancellation unit is located in a separate housing from a housing including therein an equalizer of the reception path.

There is further provided in accordance with an exemplary embodiment of the invention, a multi-sector base station, comprising a plurality of antennas adapted to communicate with primarily non-overlapping zones, a plurality of reception paths each adapted to handle frames of signals received through a respective one of the antennas and a calibration unit adapted to transmit signals between the antennas and determine a transfer function of signals between the antennas responsive to the transmitted signals.

Optionally, the calibration unit is adapted to transmit and receive the signals only through the antennas of the base station. Optionally, the calibration unit is adapted to transmit the signals during a short interval guard time of a length of less than 20 symbols, between handling of two consecutive frames.

Optionally, the base station includes a plurality of transmission paths each adapted to handle signals to be transmitted through a respective one of the antennas and an inter sector interference cancellation unit adapted to add to a first one of the transmission paths a weighted sum of the signals to be transmitted by the other transmission paths, wherein weights of the weighted sum of the transmission path are determined at least partially responsive to a transfer function determined by the calibration unit. Optionally, the interference cancellation unit is adapted to add to a first one of the reception paths a weighted sum of the signals received by the other reception paths, wherein weights of the weighted sum of the transmission path are determined at least partially from weights of the reception path.

There is further provided in accordance with an exemplary embodiment of the invention, a method of determining a parameter for adjustment of signals in a base station, comprising transmitting a test signal from a first sector antenna of a base station, receiving the test signal by a second sector antenna of the base station and determining a parameter value for adjustment of signals received or transmitted by the base station responsive to the received test signal relative to the transmitted test signal.

Optionally, transmitting the test signal comprises transmitting a signal of a time span of at most five symbols and/or during a guard time between handling of two consecutive frames. Optionally, transmitting and receiving the test signal only use antennas and modems of the base station that are also used for data transmission. Optionally, determining the parameter value comprises determining a parameter used in calculating a weight for inter-sector interference calculation.

There is further provided in accordance with an exemplary embodiment of the invention, a method of assigning frequencies to base stations, comprising providing a frequency range to be used by the base stations, dividing the frequency range into a plurality of separate frequency bands and assigning to each of the base stations one or more frequency bands, which are used for the data transmissions of the base station, such that no two adjacent base stations are assigned the same frequency band.

Optionally, assigning to each of the base stations one or more frequency bands comprises assigning to each base station a single frequency band.

There is further provided in accordance with an exemplary embodiment of the invention, a method of assigning slots for transmission between a multi-sector base station and subscribers, comprising defining for each sector slots which it is not to use, determining subscribers of a first sector that have high interference levels assigning subscribers of the first sector with high interference levels with slots that are defined not for use by one of the other sectors; and assigning subscribers of the first sector with low interference levels with slots that may be used concurrently by the other sectors of the base station.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a sectorized cellular antenna, which communicates with a plurality of subscriber stations, in accordance with an exemplary embodiment of the invention;

FIG. 2 is a block diagram of antenna station of a sector antenna, in accordance with an exemplary embodiment of the invention;

FIG. 3 is a detailed block diagram of an up stream portion of an antenna station, in accordance with an exemplary embodiment of the invention;

FIG. 4 is a schematic block diagram of a downlink stream portion of an antenna base station, in accordance with an exemplary embodiment of the invention;

FIG. 5 is a flowchart of acts performed in calculating weights used in inter-sector interference cancellation, in accordance with an exemplary embodiment of the invention;

FIG. 6 is a block diagram of a portion of physical layer units in a two sector base station, in accordance with an exemplary embodiment of the invention;

FIG. 7 is a block diagram of a portion of physical layer units of a two sector 104 base station, in accordance with another exemplary embodiment of the invention

FIG. 8 is a block diagram of a calibration unit, in accordance with an exemplary embodiment of the invention;

FIG. 9 is a schematic block diagram of a two sector base station with a diversity antenna, in accordance with an exemplary embodiment of the invention;

FIG. 10 is a schematic block diagram of inter-sector interference cancellation in a MIMO architecture, in accordance with an exemplary embodiment of the invention; and

FIG. 11 is a schematic illustration of a layout of a frequency reuse scheme, in accordance with an exemplary embodiment of the invention.

### DETAILED DESCRIPTION OF EXEMPLARY EMBODIMENTS

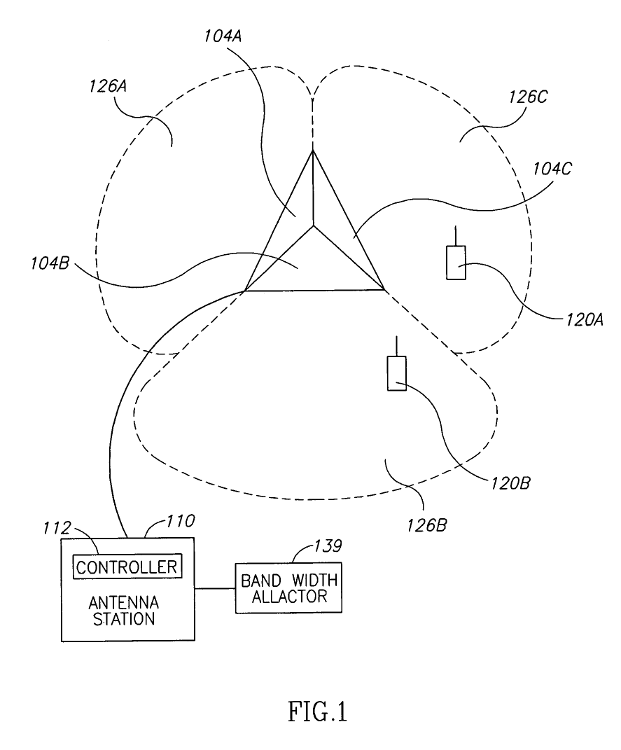

FIG. 1 is a schematic illustration of a sectorized cellular antenna 102, communicating with subscriber stations 120A and 120B, in accordance with an exemplary embodiment of the invention. Antenna 102 comprises three sectors 104A, 104B and 104C, each of which communicates with subscriber stations 120 in corresponding areas 126A, 126B and 126C of similar or different sizes. Antenna sectors 104B and 104C use the same carrier frequency concurrently for their transmissions with subscriber stations 120. An antenna station 110, under control of a controller 112 compensates for interference between different sectors 104. Referring for example to the transmissions of sector 104C, antenna station 110, under control of controller 112, adjusts the signals to be transmitted by sector 104C to subscriber station 120A, with adjustments intended to compensate for interference from transmissions of sector 104B to subscriber station 120B.

Similarly, antenna station 110 optionally decodes the signals from subscriber station 120A taking into account the interference of signals from subscriber station 120B transmitted concurrently on the same frequency, under instructions of controller 112.

In some embodiments of the invention, as discussed below, the same frequency sub-carriers are used for both uplink and downlink transmissions, at different times, according to a time domain duplex (TDD) scheme. In other embodiments of the invention, different sub-carrier frequencies are used, in accordance with a frequency domain duplex (FDD) scheme.

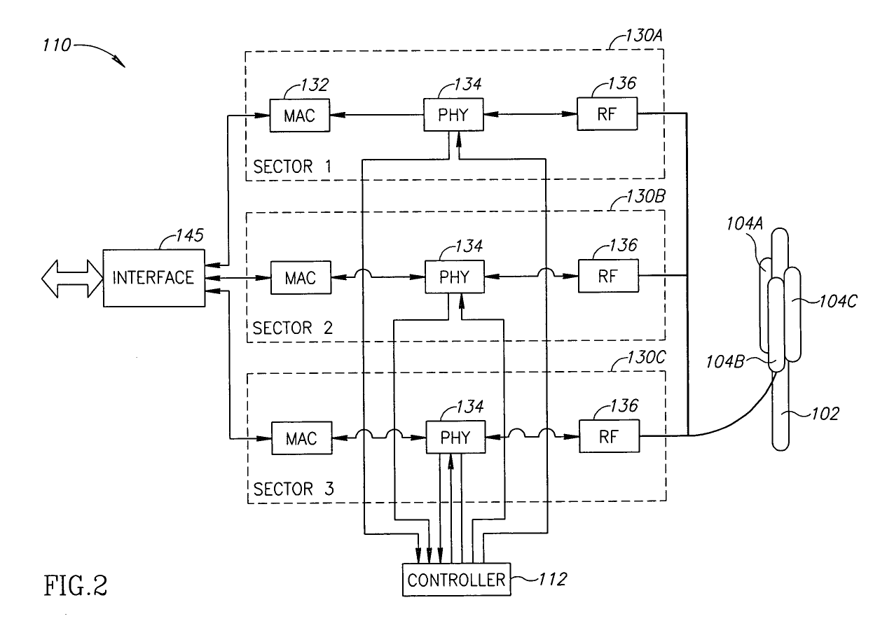

FIG. 2 is a block diagram of antenna station 110, antenna 102 and controller 112, in accordance with an exemplary embodiment of the invention. Antenna station 110 includes an interface 145 through which data to be transmitted by antenna 102 is received and data received through antenna 102 is transferred to its destination. Interface 145 may connect for example to a backbone network, such as a ground cellular network.

Each sector 104 has a respective data path 130 (marked 130A, 130B and 130C), which receives data from interface 145 and prepares it for transmission by the respective sector 104, in the downlink direction. The data path optionally also receives signals in the uplink direction from the sector 104 and translates them into signals to be passed through interface 145. In some embodiments of the invention, each data path 130 comprises a MAC unit 132, a physical layer unit 134 and an RF unit 136. The physical layer units 134 are adapted to add compensation adjustments to the received signals to compensate for interference from the transmissions of other sectors 104. Controller 112 receives data from the physical layer units 134, calculates correction parameters to be used by the physical layer units and provides the calculated adjustment values to the physical layer units 134.

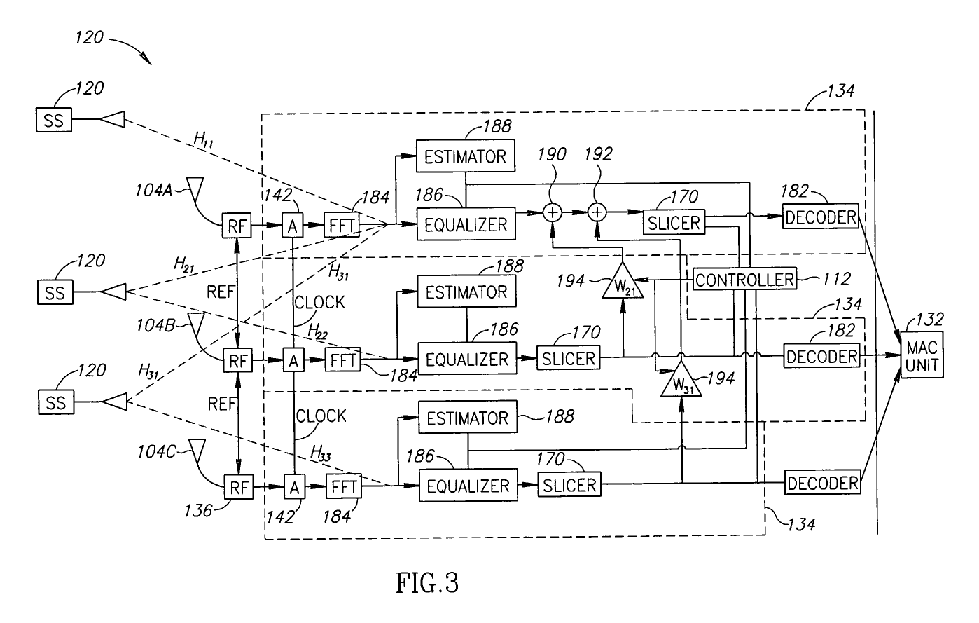

FIG. 3 is a detailed block diagram of an uplink stream portion 180 of antenna base station 110, in accordance with an exemplary embodiment of the invention. For simplicity, FIG. 3 shows correction units only with regard to antenna sector 104A. It will be appreciated by the reader that similar correction units may be inserted in the up link paths of the other sectors 104.

As shown in FIG. 3, the RF signals from RF unit 136 of each path 130 are passed to an analog to digital (ADC) converter 142 and then to a fast Fourier transform (FFT) unit 184, which passes the transformed signals to an equalizer 186. Equalizer 186 handles the signals with the aid of an estimator 188, as is known in the art. Thereafter, an inversed weighted version of the signals received concurrently by sector 104B is added to the signals by an adder 190, in order to cancel the interference from a subscriber 120B serviced by sector 104B, under the assumption that sector 104B receives the signals of subscriber 120B to a sufficient degree of accuracy for the compensation. Similarly, a weighted version of the signals concurrently received by sector 104C are added by an adder 192. The weights are applied by multipliers 194 and are determined by controller 112, as described below.

The compensated values from adder 192 are provided to a slicer 170, which provides the signals to a decoder 182. The decoded signals from decoder 182 are provided to MAC unit 132 (FIG. 2). The signals from slicers 170 are also provided to controller 112, which accordingly determines the weights of multipliers 194.

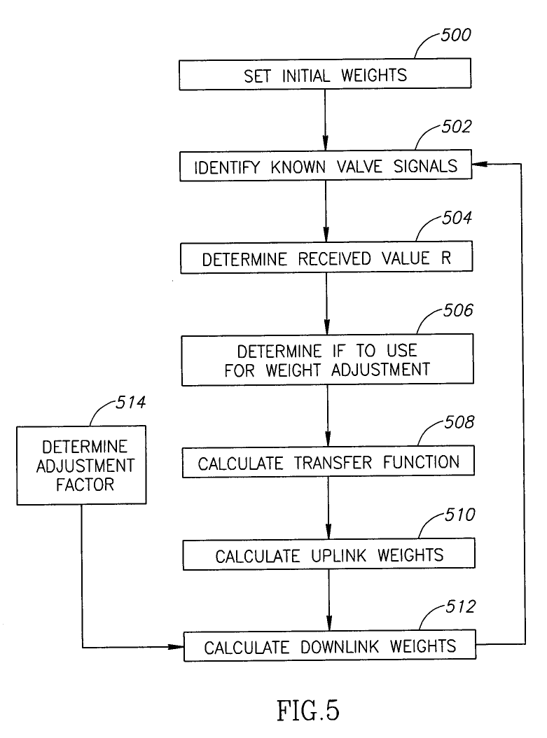

In some embodiments of the invention, the signals from the other sectors 104 provided to multipliers 194 are post slicer 170 and are already corrected for inter-sector interference. Alternatively, the input signals provided to multipliers 194 are of a version not corrected for inter-sector interference, in order not to delay the provision of the signals. Further alternatively, as described below with reference to FIG. 5, one or more auxiliary slicers may be used to prepare the signals from the other sectors 104 for multiplication by multiplier 194 and addition by adder 190 or 192.

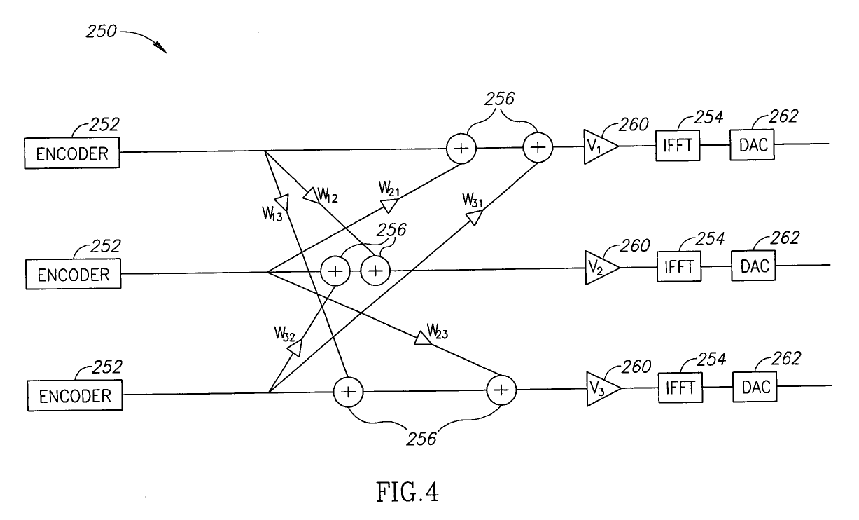

FIG. 4 is a schematic block diagram of a downlink stream portion 250 of antenna base station 110, in accordance with an exemplary embodiment of the invention. For each sector 104 (FIG. 2), downlink portion 250 includes an encoder 252 which encodes the signals transmitted by the sector. Adders 256 add weighted values of the signals of the other sectors, generated by multipliers 258. The corrected signals are optionally adjusted by multipliers 260 in order to restore their original root mean square (RMS), so that they are not distorted by digital to analog converters. The corrected signals are transformed by respective inverse fast Fourier transform (IFFT) units 254 and are provided to digital to analog converters (DACs) 262, from which they are passed to antenna sectors 104.

In some embodiments of the invention, multipliers 260 each amplify the signals of their sector by a factor vᵢ, where i represents the sector. Factor vᵢ is optionally equal to the inverse of the relative magnitude of the signals forming the corrected signal of the sector, which is the sum of 1 (representing the desired signal of the sector) and the weights applied to the signals of the other sectors before they are added to the signal of the current sector. In an exemplary embodiment of the invention, for a three sector embodiment,

$${v}_{1} = \frac{1}{\vert 1 + {w}_{21} + {w}_{31} \vert} , \\ {v}_{2} = \frac{1}{\vert 1 + {w}_{12} + {w}_{32} \vert}$$

$$and$$

$${v}_{3} = \frac{1}{\vert 1 + {w}_{13} + {w}_{23} \vert} .$$

### Weight Calculation

FIG. 5 is a flowchart of acts performed in calculating weights used in inter-sector interference cancellation, in accordance with an exemplary embodiment of the invention. At the beginning of a new transmission session, initial weight values are set (500). During reception of the signals, controller 112 identifies (502) signals that were transmitted with known values Pₖ (k representing the subscriber 120 transmitting the value) and determines (504) the received value Rₘ corresponding to the transmitted known value, for each sector m. Optionally, controller 112 determines (506) whether the known value Pₖ is to be used for weight adjustment. If the known value is to be used for weight adjustment, a transfer function H_{k,m} representing the effect of the channel on the transmitted known value, is calculated (508) for each sector m, for example according to the equation H_{k,m}=Rₘ/Pₖ. An uplink weight value is then calculated (510) based on the transfer function. A downlink weight value is optionally calculated (512) based on the uplink weight value, for example using an adjustment factor optionally determined (514) periodically. The identifying of known values and the update of the weights are optionally repeated throughout the transmission.

Referring in detail to setting (500) the initial weights, in some embodiments of the invention, the weights used in previous sessions are stored and in the beginning of a new session the most recently used stored weight values are used as the initial weights. Alternatively, the initial weights are determined from the first known value, or a first sequence of known values, determined (506) as being suitable for weight adjustment. In some embodiments of the invention, the initial weights are determined from a first preamble transmitted on the channel. Further alternatively or additionally, the weights are continuously monitored even when the subscriber station 120 is not in use, such that when a new transmission is initiated the weights for the subscriber station 120 are up to date. Further alternatively or additionally, when better weights are not available, a predetermined average weight value is used or a zero weight is used.

Referring in detail to the known signals, the data transmitted on the uplink channel optionally repeatedly includes known values such as a preamble or pilot value, which the receiver knows their value. In some embodiments of the invention, the transmission times of the known values are known in advance. Alternatively, some or all of the known values are identified by the receiver according to their values, and/or according to transmitted indications provided with the signals.

The known values may be transmitted on the channel specifically for the determination of the cancellation weights, or may be transmitted for other reasons, such as modem channel estimation or sounding, and used also for the determination of the cancellation weights.

Optionally, the base station controls the signals transmitted by the subscriber stations and has them transmitted with power levels selected such that they are received at the base station at a substantially equal power level.

With reference to the determining (504) of the received value Rₘ, in some embodiments of the invention, the received value is determined from its value after slicer 170. Optionally, the determination of the received value Rₘ in the uplink is performed after all adjustments of the received values are completed. Alternatively, for example if not feasible, the received value Rₘ is determined before one or more channel corrections are performed. In some embodiments of the invention, the weights are adjusted for this inaccuracy using a predetermined average factor.

Optionally, the received value Rₘ comprises a complex voltage.

Referring in more detail to determining (506) whether the known value is to be used, in some embodiments of the invention, the system is synchronized and the known values are orthogonal, such that when the known values are transmitted by one of the subscriber stations the other subscriber stations do not transmit signals that may interfere with the known signal. The orthoganality of the known signals may be in time, in frequency (e.g., using different sub-carriers for pilot signals by different subscribers), in modulation code or in accordance with any other orthogonality scheme. In an exemplary embodiment of the invention, the orthogonality is achieved in accordance with the Hadamar code.

In some embodiments of the invention, every time a known value is transmitted on the channel, estimation of the received signal is performed and the weights are adjusted accordingly. Alternatively or additionally, only known values which are orthogonal to the values transmitted concurrently to the other sectors are used in inter-sector cancellation. Optionally, the identity of the known signals which are orthogonal also in the short term, are predetermined. Alternatively, each time a known value is received, the orthogonality of the received signals is checked to verify that it is of a sufficient level and only known signals having sufficient orthoganality are used in estimating the weights.

Optionally, before each new transmission, a preamble of known values including at least five, ten or even 20 symbols is transmitted, in order to allow convergence of the process of weight adjustment before the transmission of data. It is noted, however, that if the channel has sufficient signal to noise ratio (SNR), a short preamble of 3, 2, or even one symbol may be used.

As to calculating (508) the transfer function, in some embodiments of the invention, the transfer function is calculated separately for each transmitted value, for example, using the equation H_{k,m}=Rₘ/Pₖ. These embodiments are optionally used when the signals have sufficient signal to noise ratio (SNR) for determination by a single known value. These embodiments allow faster operation of the inter-sector cancellation, as very little buffering is required.

Alternatively, the transfer function is determined based on a sequence of known values and the transfer function is calculated as an average of the transfer functions of the known values in the sequence.

In some embodiments of the invention, separate weights are determined for each sub-carrier and the transfer function of each sub-carrier is determined only based on the known values of the sub-carrier. Alternatively, in order to limit the number of weights to be managed and calculations to be performed, a single set of weights is determined for one or more bins of sub-carriers that include a plurality of sub-carriers. If more than one sub-carrier is included in a single bin, the transfer values are optionally calculated as an average of the transfer values of each of the sub-carriers. Alternately the weight is calculated by employing interpolator to calculate the value of weights that correspond to subcarriers in the vicinity of the known pilots.

### Bin Selection

Optionally, when the transmitted signals are carried by a plurality of separate sub-carrier frequencies (e.g., in an OFDMA scheme), separate weights are calculated for each sub-carrier frequency. Alternatively, the frequencies are grouped into adjacent bins and separate weights are calculated for each of the bins. The test signals of the bins are not necessarily on the same frequencies as the data signals of the bin, but rather may be on close frequencies. In some embodiments of the invention, the weights to be used for a specific frequency or bin are determined by interpolation from the known values in other frequencies.

The bins are optionally selected in a manner, which on the one hand minimizes the number of bins, but on the other hand minimizes the sizes of the bins, so that the difference between the required weights for any frequency in the bin and the actual weights of the bin are relatively small. In an exemplary embodiment of the invention, the size of the bin, defined by the product of the bandwidth B and the root mean square (RMS) spread delay τ is smaller or even much smaller than unity in order to make the differences between the required weight values due to differences of frequency negligible.

In some embodiments of the invention, the bins are predetermined and do not change over time. Alternatively, the bins are adaptively changed according to the transmission conditions and the level of interference.

### Uplink Weights

Referring in more detail to calculating (510) the uplink weights, in some embodiments of the invention, the weights are calculated completely from the known signals, without utilizing previous values of the weights. Optionally, in these embodiments, the received signals passed to controller 112 for determining the weights are taken from before adders 190 and 192, such that the received versions of the known values are not compensated for the inter-sector interference. Alternatively, when known values are received, the weights of multipliers 194 are set to 0, so that the received known signals do not include any compensation at all. Alternatively, the calculation of the uplink weights without utilizing previous weight values is performed in calculating initial values, for example based on a preamble of a first frame of a transmission sequence, while further weight calculations include adjustments of the current weights.

In direct calculation of the weights, the uplink weight to be used in multiplying the signals received by a sector k, representing the transmissions of a subscriber station k, in compensating for the interference of the transmissions of subscriber station k to sector m, is optionally calculated as:

W(k,m)=−H(k,m)/H(m,m),

which is minus the transfer value of the interfering subscriber to the receiving sector normalized by the transfer value of the desired subscriber to the receiving sector. As mentioned above, the transfer function is equal to:

$$H ( k , m ) = \frac{1}{n} \sum \frac{{R}_{m}}{{p}_{k}} \qquad ( 1 )$$

in which the sum progresses over all the received values belonging to a bin and/or time frame to which the transfer function H relates.

In other embodiments of the invention, the weights take into account not only the direct transfer between the corrected channel and the correcting channel, but also the indirect transfer through a different channel participating in the correction. Exemplary weight equations for a three sector base station include:

$${w}_{21}^{1} = - \frac{{H}_{21}^{1}}{{H}_{22}^{1}} + \frac{{H}_{23}^{1}}{{H}_{22}^{1}} \frac{{H}_{31}^{1}}{{H}_{33}^{1}}$$

$${w}_{31}^{1} = - \frac{{H}_{31}^{1}}{{H}_{33}^{1}} + \frac{{H}_{32}^{1}}{{H}_{33}^{1}} \frac{{H}_{21}^{1}}{{H}_{22}^{1}}$$

$${w}_{12}^{1} = - \frac{{H}_{21}^{1}}{{H}_{11}^{1}} + \frac{{H}_{13}^{1}}{{H}_{11}^{1}} \frac{{H}_{31}^{1}}{{H}_{33}^{1}}$$

$${w}_{32}^{1} = - \frac{{H}_{32}^{1}}{{H}_{33}^{1}} + \frac{{H}_{31}^{1}}{{H}_{33}^{1}} \frac{{H}_{12}^{1}}{{H}_{11}^{1}}$$

$${w}_{13}^{1} = - \frac{{H}_{13}^{1}}{{H}_{11}^{1}} + \frac{{H}_{12}^{1}}{{H}_{11}^{1}} \frac{{H}_{23}^{1}}{{H}_{22}^{1}}$$

$${w}_{23}^{1} = - \frac{{H}_{23}^{1}}{{H}_{22}^{1}} + \frac{{H}_{21}^{1}}{{H}_{22}^{1}} \frac{{H}_{13}^{1}}{{H}_{11}^{1}}$$

Alternatively to using these values, without relation to previous values of the weights, the weights to be used may be generated as an average between the currently calculated weights and one or more previous calculated weights.

### Continuous Adjustment of Uplink Weights

In some embodiments of the invention, in calculating (510) the uplink weights the received signals passed to controller 112 are taken from after adders 190 and 192 and have the following format:

ro₁=r₁−w₂₁*r₂−w₃₁*r₃

where ro₁ is the received value passed to controller 112 for a first sector and r₁, r₂ and r₃ are the actually received values before their correction. Using the corrected received values, controller 112 calculates the transfer functions using equation (1) above and then calculates weight correction values using the same equations used above for calculating the weights, e.g.,

$$Δ {w}_{21}^{i} = - \frac{{H}_{21}^{i}}{{H}_{22}^{i}} + \frac{{H}_{23}^{i}}{{H}_{22}^{i}} \frac{{H}_{31}^{i}}{{H}_{33}^{i}} .$$

The actual correction is optionally performed using the following equation:

w_{xy}ⁱ⁺¹=w_{xy}ⁱ+LG*Δw_{xy}

in which LG is a loop gain factor between 0-1 depending on a desired convergence path and/or the noisiness of the network and i is an iteration indicator. Exemplary values of LG include 1, 0.5 and 0.6, although other values may be used. In some embodiments of the invention, LG is predetermined and does not change. Alternatively, LG is adjusted dynamically, for example, according to the network conditions.

### Downlink Weights

Referring in more detail to calculating (512) the downlink weights, in some embodiments of the invention, the downlink weights are determined by multiplying each of the uplink weights by an adjustment factor G_{xy}. Optionally, the adjustment factor represents the relative difference between the transmitters and receivers involved in the uplink and downlink transmissions, as discussed in detail further hereinbelow.

The use of the adjustment factor for determining the downlink weights from the uplink weights is particularly useful in those cases in which the uplink and downlink signals are transmitted on similar channels, for example using the same sub-carriers, for example when the uplink and downlink transmissions use the same sub-carriers, for example, in accordance with a time domain duplex (TDD) scheme. While using the adjustment factor in determining the downlink weights may be in some cases less accurate, it avoids the need to employ the subscriber stations which may be battery operated in additional activities.

In some embodiments of the invention, for example when the uplink and downlink transmissions have very different conditions (e.g., are on different frequencies), the weights of the downlink are determined separately from the uplink weights. The different conditions of the uplink and downlink, may be due, for example to use of different frequencies, in accordance with a frequency domain duplex (FDD) scheme.

Optionally, the subscriber stations receive known signals, determine their values and transmit the determined values to controller 112. Controller 112 uses this information to determine the downlink weights in a manner similar to that described above regarding the uplink. Alternatively to controller 112 receiving raw data from the subscriber stations 120 and determining the downlink weights accordingly, the subscriber stations may perform some or all of the calculations. The known signals transmitted to the subscriber stations 120 from the different sectors 104 are optionally orthogonal to each other, so that they may be transmitted concurrently. The orthogonality may be in accordance with any of the schemes described above, such as frequency, time or code. Alternatively to concurrent transmission, the known signals are transmitted through the sectors 104 at different times, allowing use of the same signals for a plurality of the sectors.

Sector Adjustment Factor The adjustment factor is optionally determined (514) periodically, based on transmissions between the sectors. Optionally, once every predetermined time and/or when the base station has free bandwidth, each of the sector antennas 104 transmits an adjustment factor calibration signal. Optionally, for simplicity, all the sectors 104 transmit the same calibration signal. The calibration signal is optionally a short sequence of symbols for each of the frequency bins, possibly including fewer than 5, or even only 2 or one symbols.

In some embodiments of the invention, the calibration signals are transmitted sequentially, one sector 104 transmitting and all the other sectors receiving the signal and determining the adjustment factor. Alternatively, a plurality of sectors 104 transmit non-identical orthogonal calibration signals together. For example, in a round robin order, one of the sectors 104 may operate as a receiver and all the other sectors transmit calibration signals.

The receiving sectors measure the signal they receive responsive to the transmitted calibration signal. The ratio between the signal r_{AB} received by a sector 104A from a sector 104B and the signal r_{BA} received by sector 104B from sector 104A is optionally used as the adjustment factor G_{AB} (G_{AB}=r_{AB}/r_{BA}) for conversion of the uplink weight used in multiplying the signal from sector A for correction of the signal of sector B, into a downlink weight for multiplying the signal to be transmitted by sector A for correction of the signal transmitted by sector B. The transmitted calibration signals are optionally transmitted with a relatively low amplitude, relative to data signals which are generally transmitted when none of the other sectors is operating as a receiver, in order to prevent saturation of the neighboring sectors receiving the signal.

Optionally, each time calibration signals are transmitted, all the sectors have a chance to transmit their calibration signal before the base station returns to transmit/receive data. Thus, all the adjustment factors G are adjusted at substantially the same time. Alternatively, each time the base station has a gap in its data transmission, which is used for the calibration signals, calibration signals are transmitted by a single sector 104, thus allowing utilization of short gaps for the calibration. The sectors optionally transmit their calibration signals in a round robin order, although any other order may be used.

In some embodiments of the invention, the calibration signals are transmitted during a guard time conventionally not used for data transmission, between the handling of two consecutive frames. The guard time may be, for example between the end of transmission of a frame by the base station and the beginning of receiving a frame from a subscriber or between the end of receiving a frame and the beginning of transmission of a subsequent frame. Alternatively or additionally, the guard time is between transmission of two consecutive frames or reception of two consecutive frames. The guard time is optionally very short and is used to allow for differences in propagation times through the cell. The guard time is optionally relatively short, being of a period of less than 100 or even less than 50 symbols. In some embodiments of the invention, the guard time is very short and has a span of only several symbols, for example not more than 10 symbols or even less than five symbols. In an exemplary embodiment of the invention, the guard time has a period of 2-3 symbols. Each symbol optionally corresponds to a time span of between about 10-500 microns, for example 100 microns, although longer or shorter time spans may be used.

Alternatively to using the same signal value for all the transmitted calibration signals, different signal values are used and the results are adjusted according to the relative values of the calibration signals. Possibly, the calibration signals are transmitted only for the determination of the adjustment factor. Alternatively, signals which any how would have been transmitted, possibly even data signals, are used for the determination of the adjustment factor, as the base station is both the transmitter and the receiver and has all the information on the transmitted and received signals.

In some embodiments of the invention, the adjustment factor is updated at a high rate, for example every time the uplink weights are determined. Alternatively, the adjustment factor is adjusted at a low rate, for example less than once every 10, 100, or even less than once every 1000 adjustments of the uplink weights.

### Use Plurality of Iterations

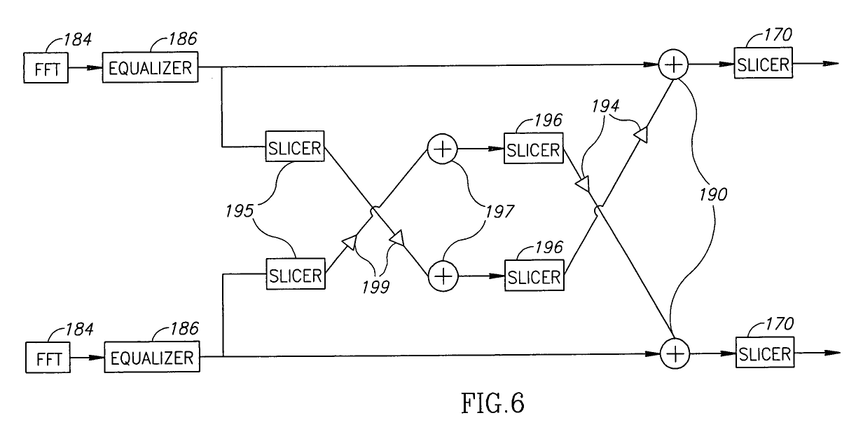

FIG. 6 is a block diagram of an uplink portion of the physical layer units 134 in a two sector 104 base station, in accordance with an exemplary embodiment of the invention. In the embodiment of FIG. 6, the version of the signal from the other sector applied to adder 190 to remove inter-sector interference is first itself compensated for inter-sector interference at an adder 197. In producing the compensated version, the signal of the main sector is optionally provided to a slicer 195 and then multiplied by its respective weight at a multiplier 199. This uncorrected weighted version of the main sector is added to the signal of the other sector at adder 197 to produce a compensated version of the signal of the other sector. The compensated version is passed through a slicer 196 and is then multiplied by multiplier 194 and used at adder 190 to compensate for inert sector interference in the signal of the main sector.

It is noted that in some embodiments of the invention additional stages of interference compensation may be used.

### Alternative Implementation

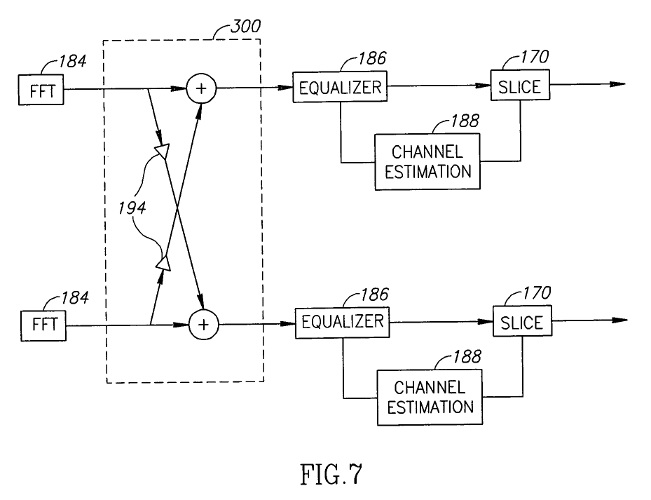

In the above description, the cancellation in the uplink direction is performed between the equalizer 186 and decoder 182, within the demodulation process, and the cancellation in the downlink direction is performed between encoder 252 and IFFT 254 (FIG. 4). In other embodiments of the invention, the inter-sector cancellation is performed elsewhere in the transmission/reception paths 130, for example earlier in the uplink reception path as is now described with reference to FIG. 7 or later in the reception uplink path, optionally within decoder 182. In the downlink direction, the compensation may be performed, for example, within encoder 252 and/or after multipliers 260.

Performing the cancellation within the modem, e.g., within encoder 252 (FIG. 4) and/or after equalizer 186 in the direction to encoder 182, may allow performing the interference cancellation using less processing power.

FIG. 7 is a block diagram of a portion of the physical layer units 134 of a two sector 104 base station, in accordance with another exemplary embodiment of the invention. In the embodiment of FIG. 7, an inter-sector cancellation unit 300 is positioned between FFT units 184 and equalizers 186. This position of cancellation unit 300 may allow the cancellation unit easy installation in existing systems. The weights to be used by multipliers 194 of cancellation unit 300 are optionally determined as described above with reference to FIG. 5. Alternatively, the weight determination is performed based on the transfer function of the signals after FFT 184, rather than the transfer function of the signals after slicers 170.

### Stand Alone Implementation

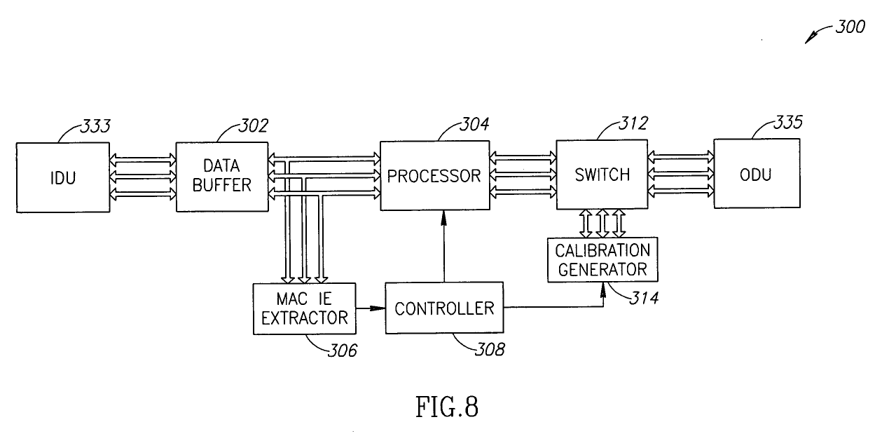

FIG. 8 is a block diagram of a hardware implementation of cancellation unit 300, in accordance with an exemplary embodiment of the invention. Cancellation unit 300 of FIG. 8 includes a data buffer 302 in which data is stored while waiting for inter-sector compensation, a processor 304, which performs the compensation, e.g., implements adders 190 and multipliers 194 and a controller 308 which calculates the weights and/or performs other control tasks. In some embodiments of the invention, a MAC extractor 306 analyzes the data signals to determine their structure, e.g., where the known values are transmitted, the identities of the subscribers and/or the channels used by the subscribers, to aid controller 308 in its task.

Optionally, a calibration generator 314 generates calibration signals for determining the direct transfer function between the sectors 104 (FIG. 2) and a switch 312 controls the flow of signals toward the antennas.

In some embodiments of the invention, cancellation unit 300 is a stand alone unit which does not sit in the same housing with equalizer 186, encoder 252 and/or decoder 182. Optionally, cancellation unit 300 is a separate unit in a separate housing located between an in door unit (IDU) 333 and an out door unit (ODU) 335, for example in a WiMax architecture. In some embodiments of the invention, cancellation unit 300 is located between FFT units 184 and 254 on the one hand, and DACs 262 and ADCs 142, on the other hand, thus being completely outside the modems. These embodiments allow simpler interfacing of cancellation unit 300 into existing systems. Optionally, if required, cancellation unit 300 includes additional FFT/IFFT units at its input and output, so that the signals can be received in the downlink after IFFT 254 and in the uplink before FFT 184.

Processor 304 may be implemented by a general purpose processor or a DSP or may be implemented by an FPGA or dedicated hardware. The implementation of cancellation unit 300 is provided as an example and many other implementations may be used including more software or more hardware oriented implementations.

### Diversity and MIMO

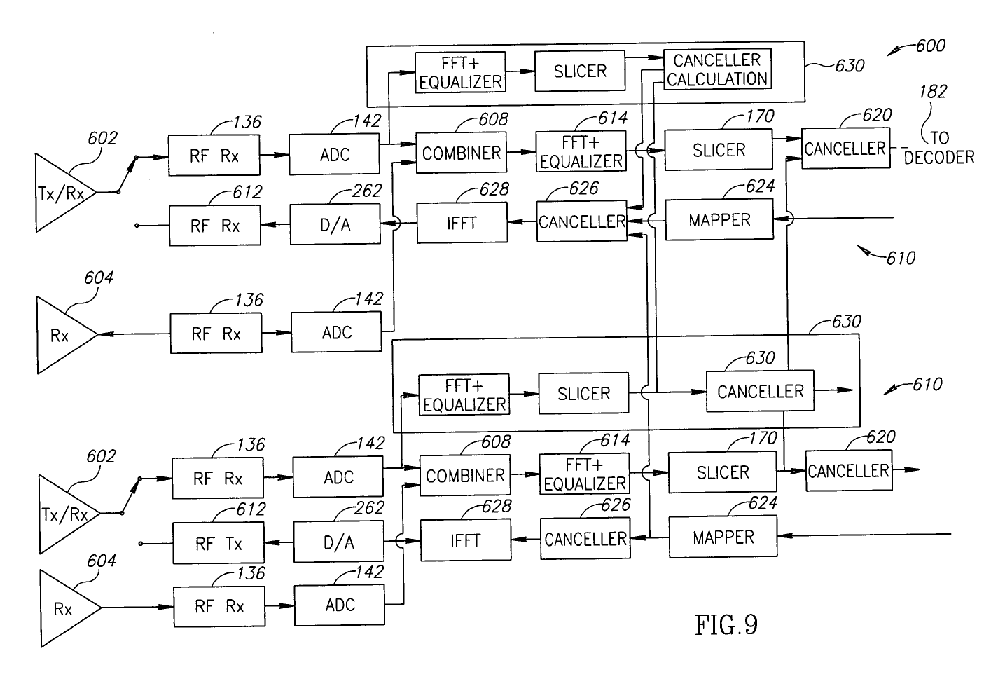

The above described inter-sector cancellation is not limited to systems with a single antenna in each sector 104. In some embodiments of the invention, one or more sectors 104 have an additional antenna only for reception and the signals of the antennas are combined before they are provided for FFT transformation. Optionally, in these embodiments, a dummy path is added for determining the cancellation weights, as is now described with reference to FIG. 9.

FIG. 9 is a schematic block diagram of a two sector base station 600, in accordance with an exemplary embodiment of the invention. Base station 600 includes two sectors 610. Each sector includes a dual purpose antenna 602 used for both transmission and reception and an additional diversity antenna 604. RF reception units 136 and ADCs 142 convert the received signals into digital values. Similarly, DACs 262 and RF transmission units 612 convert digital signals into RF signals for transmission. A combiner 608 combines the digital signals received through both antennas. The combined signals are passed through an FFT and equalizer unit 614 and then through a slicer 170 to an inter-sector cancellation unit 620. The signals from the canceller are provided towards decoder 182.

In the downlink path, the signals to be transmitted are passed through a mapper 624, an uplink cancellation unit 626 and an IFFT unit 628 to DAC 262. A dummy path 630 processes only the signals received through dual purpose antenna 602, in parallel to the main processing of the signals from combiner 608. The signals from the dummy path are used for calculating the weights and/or for cancelling the inter-sector interference.

Inter-sector cancellation may be used also in many input many output (MIMO) architectures. Optionally, when a MIMO architecture is used, each of the antennas uses separate known values which are orthogonal to all the other antennas, those in its sector and those in other sectors. The received signals of each antenna of a sector are optionally compensated for the interference of each of the antennas of the other sectors using the same methods described above for the single antenna per sector architecture. For example, for a three sector×2 MIMO architecture, each of the two signals of the antennas of a sector is compensated for inter-sector interference by adding a weighted version of the signals of each of the four antennas of the other sectors.

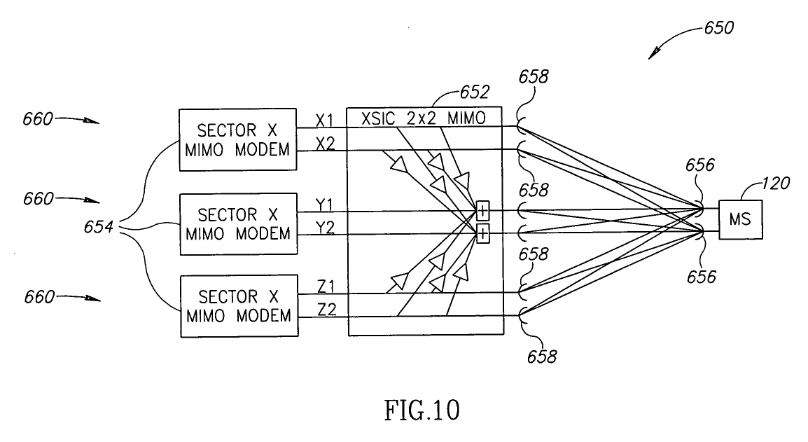

FIG. 10 is a schematic block diagram of a MIMO base station 650, in accordance with an exemplary embodiment of the invention. Base station 650 comprises three sectors 660, each of which includes a MIMO modem 654 and a pair of antennas 658, which communicate with respective antennas 656 in a subscriber station 120. An inter-sector cancellation unit 652, illustrating signal correction only for the downlink of the middle sector 660, adds to each of the signals to be transmitted by the antennas 658 a weighted sum of the signals to be transmitted by all the antennas of the other sectors.

### Sub-Band Allocation

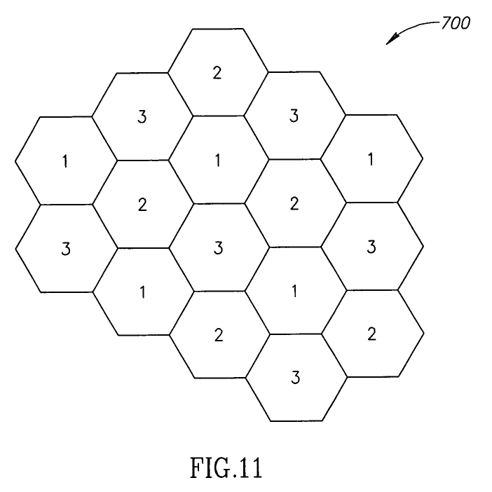

FIG. 11 is a schematic map of a frequency band allocation scheme between cells of a cellular network 700, in accordance with an exemplary embodiment of the invention. The frequency range (e.g., 10 MHz, 30 MHz) of cellular network 700 is divided into three bands marked, 1, 2 and 3. Each base station is assigned for its cell in network 700, one of the bands, in a manner that all its adjacent neighbor base stations use bands different from the band used by the base station. Thus, the interference between cells is very low. Optionally, the frequency range is divided into three different bands, which are sufficient to allow all adjacent base stations to use different bands. If the base stations use multi-sector antennas, the base station optionally uses the above described inter-sector cancellation methods, to allow all the sectors of the base station to use the same frequency range.

Alternatively to each base station using a single frequency band, one or more of the base stations is assigned a plurality of frequency bands, for example a band for each sector. If two bands are assigned to each base station, the frequency range of the network is optionally divided into at least six bands to allow adjacent base stations not to require use of any common frequency bands. In an exemplary embodiment of the invention, each base station of three sector antennas is assigned two bands for transmissions, such that two of the sectors are required to share a single band. It is noted, however, that the inter-sector cancellation is less demanding than when all the sectors of a base station use a single band. In other embodiments of the invention, each sector is assigned a separate band and the frequency range is divided into at least nine bands.

Alternatively, all the cells of the network use the entire available frequency range, i.e., the frequency range is assigned to a single frequency band.

### Slot Allocation

In some embodiments of the invention, the base stations allocate slots (e.g., a bandwidth allocator 139 (FIG. 1)) for uplink and/or downlink transmissions to subscriber stations for each sector independently of the allocation to other sectors 104 and of the allocations in neighboring base stations. These embodiments may be used, for example when the above inter-sector cancellation methods are used at a high efficiency level. Alternatively, the slot allocation in one sector depends on the allocation in other sectors and/or in other base stations.

In an exemplary embodiment of the invention, high priority data (e.g., management data, real time data and/or data of a high priority ranked subscriber station) and/or data to a subscriber station suffering from high interference levels is allocated bandwidth not used concurrently by one or more of the other sectors. The high interference level of a subscriber station is identified, for example, when the transmission rate to/from the subscriber station is low and/or when more than a predetermined number of retransmissions were required.

Optionally, when broadcast data needs to be transmitted to more than one sector, the data is transmitted in a broadcast on the same slot concurrently by the plurality of sectors. In some embodiments of the invention, the bandwidth allocation messages are transmitted in broadcast messages in all the slots concurrently.

In some embodiments of the invention, the uplink bandwidth slots are allocated according to the power level at which transmissions from the subscribers reach the sector antennas 104, in a manner which minimizes the interference between the transmissions of subscribers using the same slot. Optionally, the base station manages a table in which it records for each subscriber and sector, the amplitude of the signals from the subscriber is received by the sector. According to the contents of the table, the base station optionally allocates the same slot to a plurality of subscriber stations which meet the requirement that have at least a predetermined difference between their amplitude at each of the sector antennas 104 which are to receive their transmissions.

Optionally, the base station may adjust one or more transmission parameters in the uplink or downlink responsive to the table contents. For example, if it is determined that the interference between the transmissions of two sectors is too high, one or both of the sectors may change its transmission parameters to achieve a better immunity to interference, for example by lowering the constellation level, increasing the transmission power and/or lowering modulation or code rates. The subscribers allocated slots with low transmission rates are optionally those which require smaller bandwidth amounts. Accordingly, the allocation is performed based on the transmission rates required by the subscribers, in addition to the values in the table.

In some embodiments of the invention, in the downlink, power boosting is used to increase the transmission power to a first subscriber having a low reception level from a first sector and to decrease the power level to a second subscriber from a second sector, in order to allow transmission from both the sectors to the subscribers in the same slot.

### Table Construction

The values of the table are optionally determined based on periodic test transmissions between the subscribers and the sector antennas. In some embodiments of the invention, the test transmissions are transmitted only in a single direction, for example from the base station to the subscribers. Alternatively, test transmissions are transmitted in both directions, for example when the different directions use frequencies with substantially different characteristics. In some embodiments of the invention, the table manages for each pair of subscriber and sector a single value. Alternatively, each pair of subscriber and sector has a plurality of values in the table, for example for each sub-carrier or bin of sub-carriers.

The test transmissions are optionally designed to probe the entire frequency band of the connection. In some embodiments of the invention, the test transmissions include dedicated power ranging messages. Alternatively the test transmissions are used also for other purposes, such as bandwidth allocation requests (e.g., reverse link allocation of WiMax), frame preambles, training signals or even data signals. The test signals are optionally transmitted without interfering signals or only with signals that are orthogonal thereto.

### Cross Base Station Allocation Coordination

In some embodiments of the invention, the power value tables manage entries also for subscribers of neighboring base stations. Optionally, the base stations exchange lists of subscribers they are servicing and accordingly determine the power levels in which they receive the transmissions of the subscribers of neighboring base stations. Each base station optionally identifies the subscribers that are problematic to its transmissions and requests the neighboring base stations to assign their subscribers slots that it will not be using. Alternatively or additionally, the determined power levels are exchanged between the base stations and their data is used by the base stations in the allocation of slots using any of the methods described above for inter-sector interference.

Optionally, in order to simplify or eliminate the need for communications between the base stations, each of the base stations (or each of the sectors of the base stations) is defined slots which it is not to use and/or slots which it is to use only for transmissions which have high immunity to noise and/or interference. In some embodiments of the invention, other slots may be defined, such as downlink slots which are used with up to a maximal amplitude boosting level.

Optionally, the percentage of non transmission slots and/or limited use slots assigned to each base station is determined by a central controller or by a distributed base station protocol. In some embodiments of the invention, each base station increases its amount of limited and/or non use slots as much as possible according to its current load and the quality of service (QoS) rankings of the subscribers it is currently servicing. When the needs of a base station increases it optionally requests an increase from its neighboring base stations and/or from the central controller. In some embodiments of the invention, a plurality of schemes of slot rankings are defined for each base station for different non-use and limited use slot percentages. When the scheme is changed, the base station merely identifies the scheme to which it is changing in a transmission to the neighboring base stations.

In determining slot allocations for a specific sector or base station, the base station optionally takes into account which slots are not used by interfering neighbors and assigns these slots to subscribers having most important data and/or having worst channel conditions.

While the above description relates to compensation in both the uplink and downlink, in some embodiments of the invention, base stations may perform inter-sector compensation only in the uplink or only in the downlink, for example if the other direction has sufficient interference immunity with the compensation and/or requires lower bandwidth.

Although the above description related by way of example to orthogonal frequency division multiple access (OFDMA) transmissions, the methods of at least some embodiments of the invention can be used with substantially any transmission method, including, but not limited to, FDMA, TDMA, CDMA and OFDM or an any other multiple access method.

The subscriber stations 120 described above may be substantially any units which can utilize point to multipoint transmissions. For example, subscriber stations 120 may include cellular telephones, personal digital assistants (PDAs), laptops, computers or television sets, as well as both mobile and/or stationary units.

Furthermore, while the above description refers to cellular networks, the methods of at least some embodiments of the present invention may be used in other point to multipoint networks, such as WiMax (Worldwide Interoperability for Microwave Access) and LMDS (Local multipoint distribution system) networks.

It will be appreciated that the above described methods may be varied in many ways, including, changing the order of acts (for example performing act 506 before act 504 or concurrently therewith), and/or performing a plurality of steps concurrently. It should also be appreciated that the above described description of methods and apparatus are to be interpreted as including apparatus for carrying out the methods, and methods of using the apparatus. The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

1. A method of communicating in a cellular network, comprising:
providing a multi-sector point to multipoint base station, including a plurality of antennas covering primarily non-overlapping zones;
allocating bandwidth to a subscriber station in each of the zones, which bandwidth is on a single channel, such that if the subscribers were adjacent each other their transmissions on the allocated bandwidth would interfere with each other;
transmitting signals from the subscribers to the base station through the antennas of the respective zones in which they are located, on the allocated bandwidth; and
processing the signals from each of the subscribers so as to cancel interference from others of the subscribers in interpreting the signals by the base station.

2. A method according to claim 1, wherein the plurality of antennas are located in a single location.

3. A method according to claim 1, wherein the plurality of antennas are located on a single tower.

4. A method according to claim 1, wherein the plurality of antennas comprise directional antennas.

5. A method according to claim 1, wherein each of the zones covers a sector surrounding the base station and the zones together cover the entire surroundings of the base station.

6. A method according to claim 1, wherein processing the signals comprises adding to each of the received signals a weighted sum of the signals received by one or more other antennas, the weights being designed to cancel interference from the subscribers generating the signals received by the other antennas.

7. A method according to claim 6, wherein transmitting the signals from the subscribers comprises transmitting signals which intermittently include values known by the base station in advance and comprising using the received values of the transmitted known values in determining weights for the weighted sum.

8. A method according to claim 7, wherein transmitting the known values comprises transmitting to the plurality of antennas concurrently, signals which are orthogonal to each other.

9. A method according to claim 6, wherein the adding of the weighted sum of the signals of the one or more other antennas is performed after the signals are handled by an equalizer.

10. A method according to claim 6, wherein the adding of the weighted sum of the signals of the one or more other antennas is performed before the signals are handled by an equalizer.

11. A method according to claim 1, comprising transmitting data signals from the base station through the plurality of antennas concurrently, on a single channel.

12. A method according to claim 11, wherein the data signals transmitted from the base station are corrected for inter-sector interference before their transmission.

13. A method according to claim 12, wherein the correction of the data signals transmitted from the base station is performed using downlink weights determined from a transfer function of signals transmitted to the base station.

14. A method according to claim 13, wherein the downlink weights are derived from uplink weights used in correcting signals received by the base station, by multiplying by an internal transfer factor between the plurality of antennas.

15. A method according to claim 14, wherein the base station periodically transmits test signals between the plurality of antennas and accordingly determines the internal transfer factor.

16. A method according to claim 15, wherein the periodically transmitted test signals are transmitted during a guard time between an end of a first transmission frame and a beginning of a subsequent transmission frame.

17. A method according to claim 1, wherein each zone is covered only by a single antenna belonging to the base station.

18. A method according to claim 1, wherein transmitting signals from the subscribers to the base station comprises transmitting on a plurality of sub-carriers and wherein processing the signals comprises processing the signals using weights determined separately for a plurality of bins of sub-carriers, each bin including one or more sub-carriers.

19. A method according to claim 18, wherein at least one bin includes a plurality of sub-carriers.

20. A method according to claim 18, wherein each of the bins includes only a single sub-carrier.

21. A method according to claim 1, wherein providing the base station comprises providing a base station in which each of the plurality of antennas covering primarily non-overlapping zones is associated with an additional antenna covering substantially the same zone.

22. A method according to claim 21, wherein the plurality of antennas covering primarily non-overlapping zones and the associated additional antennas are employed together in accordance with a MIMO architecture.

23. A method according to claim 22, wherein processing the signals comprises adding to the signal received from a first subscriber, a weighted sum of the signals received through each of the antennas not included in the same sector as the antenna through which the signal from the first subscriber was received.

24. A method according to claim 1, wherein processing the signals from each of the subscribers comprises based on a transfer function measured on previously transmitted test signals.

25. A method according to claim 24, wherein the previously transmitted test signals and the processed signals are transmitted on different frequencies.

26. A method according to claim 25, wherein a value determined for use in the processing of the signals is determined from the previously transmitted test signals by interpolating from test values of frequencies adjacent to the frequencies of the processed signals.

27. A method of communicating in a cellular network, comprising:
providing a multi-sector point to multipoint base station, including a plurality of antennas covering primarily non-overlapping zones;
generating signals to be transmitted concurrently through the plurality of antennas;
processing the generated signals so as to cancel interference between the signals when transmitted through the plurality of antennas; and
transmitting the processed signals through the antennas concurrently, on a single channel, such that if the antennas covered overlapping zones the signals would substantially interfere with each other.

28. A method according to claim 27, wherein the base station comprises at least three antennas.

29. A method according to claim 27, wherein processing the generated signals comprises adding to each signal a weighted sum of the signals to be transmitted through the other antennas.

30. A method according to claim 27, wherein processing the generated signals comprises processing after the signals are inverse Fourier transformed.

31. A multi-sector base station, comprising:
a plurality of antennas adapted to communicate with primarily non-overlapping zones;
a plurality of reception paths each adapted to handle signals received through a respective one of the antennas; and
an inter sector interference cancellation unit adapted to add to a first reception path a weighted sum of the signals received by the other reception paths, wherein weights of the weighted sum are selected responsive to an inter-sector interference level.

32. A base station ac cording to claim 31, wherein the plurality of antennas comprise directional antennas.

33. A base station ac cording to claim 31, wherein the cancellation unit is adapted to receive received values of signals of predetermined known transmitted values and accordingly determine the weights.

34. A base station ac cording to claim 31, wherein the cancellation unit is adapted to add the weighted sum after an equalizer in the reception path.

35. A base station ac cording to claim 31, wherein the cancellation unit is adapted to add the weighted sum before an equalizer in the reception path.

36. A base station according to claim 31, wherein the cancellation unit is located in a separate housing from a housing including therein an equalizer of the reception path.

37. A multi-sector base station, comprising:
a plurality of antennas adapted to communicate with primarily non-overlapping zones;
a plurality of reception paths each adapted to handle frames of signals received through a respective one of the antennas; and
a calibration unit adapted to transmit signals between the antennas and determine a transfer function of signals between the antennas responsive to the transmitted signals.

38. A base station ac cording to claim 37, wherein the calibration unit is adapted to transmit and receive the signals only through the antennas of the base station.

39. A base station ac cording to claim 37, wherein the calibration unit is adapted to transmit the signals during a short interval guard time of a length of less than 20 symbols, between handling of two consecutive frames.

40. A base station according to claim 37, comprising:
a plurality of transmission paths each adapted to handle signals to be transmitted through a respective one of the antennas; and
an inter sector interference cancellation unit adapted to add to a first one of the transmission paths a weighted sum of the signals to be transmitted by the other transmission paths, wherein weights of the weighted sum of the transmission path are determined at least partially responsive to a transfer function determined by the calibration unit.

41. A base station according to claim 37, wherein the interference cancellation unit is adapted to add to a first one of the reception paths a weighted sum of the signals received by the other reception paths, wherein weights of the weighted sum of the transmission path are determined at least partially from weights of the reception path.

42. A method of determining a parameter for adjustment of signals in a base station, comprising:
transmitting a test signal from a first sector antenna of a base station;
receiving the test signal by a second sector antenna of the base station; and
determining a parameter value for adjustment of signals received or transmitted by the base station responsive to the received test signal relative to the transmitted test signal.

43. A method according to claim 42, wherein transmitting the test signal comprises transmitting a signal of a time span of at most five symbols.

44. A method according to claim 42, wherein transmitting the test signal comprises transmitting during a guard time between handling of two consecutive frames.

45. A method according to claim 42, wherein transmitting and receiving the test signal only use antennas and modems of the base station that are also used for data transmission.

46. A method according to claim 42, wherein determining the parameter value comprises determining a parameter used in calculating a weight for inter-sector interference calculation.

47. A method of assigning frequencies to base stations, comprising:
providing a frequency range to be used by the base stations;
dividing the frequency range into a plurality of separate frequency bands; and
assigning to each of the base stations one or more frequency bands, which are used for the data transmissions of the base station, such that no two adjacent base stations are assigned the same frequency band.

48. A method according to claim 47, wherein assigning to each of the base stations one or more frequency bands comprises assigning to each base station a single frequency band.

49. A method of assigning slots for transmission between a multi-sector base station and subscribers, comprising:
defining for each sector slots which it is not to use;
determining subscribers of a first sector that have high interference levels;
assigning subscribers of the first sector with high interference levels with slots that are defined not for use by one of the other sectors; and
assigning subscribers of the first sector with low interference levels with slots that may be used concurrently by the other sectors of the base station.
